(19) United States
(12) Patent Application Publication
(10) Pub. No.: US 2007/0192127 A1
(43) Pub. Date: Aug. 16, 2007

(54) PRESS RELEASE MANAGEMENT SYSTEM APPARATUS AND METHOD

(76) Inventor: David McInnis, Ferndale, WA (US)

Correspondence Address: UTAH VALLEY PATENT SERVICES, LLC, 846 S. 1350 E., PROVO, UT, 84606, US

(21) Appl. No.: 11/674,480

(22) Filed: Feb. 13, 2007

Related U.S. Application Data
(60) Provisional application No. 60/773,977, filed on Feb. 16, 2006.

(51) Int. Cl. G06Q 10/00

(52) U.S. Cl. 705/1

(57) ABSTRACT

A press release server serves up a first web page with a press release management console and receives a press release and trackback management settings therethrough. The press release server serves up a second web page with the press release and a press release trackback URL. The press release server receives trackback requests at a first address corresponding to the press release trackback URL and manages the trackback request according to the trackback management settings. In some embodiments, the press release server includes a trackback post corresponding to the trackback request in the second web page. In some embodiments, the press release server sends a trackback request to a second address corresponding to a trackback URL of a related web page received through the press release management console.

### RELATED APPLICATIONS

This application claims priority to U.S. Provisional Patent Application No. 60/773,977 entitled “Business Method for Incorporating TrackBacks (Backlinks), Tag Spaces and Podcast Interviews in Press Release Distribution Service” and filed on 16 Feb. 2006 for David Aaron McInnis. The aforementioned application is incorporated herein by reference.

### BACKGROUND OF THE INVENTION

1. Field of the Invention

The present invention relates to publicizing press releases. Specifically, the invention relates to apparatus, systems, and methods to manage a press release.

2. Description of the Related Art

Companies, organizations, associations, and the like often communicate with the general public through press releases. A press release may include any public relations announcement such as the release of a new product, service, or other development. Common approaches to publicizing press releases include publishing the press release on the Internet. Though publishing a press release on the Internet may create some level of press release exposure, certain limitations exist.

For example, a new company may decide to publish a press release regarding a new product on the company's website. Because the company is new, the website may experience very little traffic. Without other websites directing traffic to the press release, the press release is likely to experience little exposure. The limited press release exposure may compromise the potential success of the new product or require the company to invest time and money to pursue additional marketing strategies.

Additionally, should someone happen upon the company's press release, he or she may have difficulty finding additional sources discussing, verifying, or otherwise relating to the press release. The lack of additional sources may adversely affect the press release viewer's reaction to the press release. For example, a potential client may decide to forego purchasing the new product as the press release is unsupported by independent sources. Also, a reporter may decide to forego reporting on the press release because of an insufficient pool of information, resulting in a lost opportunity to propagate the press release.

Given the aforementioned issues and challenges related to publicizing a press release, a need exists for an apparatus, system, and method for linking a press release to related web pages. Beneficially, such a system, apparatus, and method would enhance press release publication by directing traffic from related web pages to the press release web page and by including references to related web pages in the press release web page.

### SUMMARY OF THE INVENTION

The present invention has been developed in response to the present state of the art, and in particular, in response to the problems and needs in the art that have not yet been fully solved by currently available press release publication means and methods. Accordingly, the present invention has been developed to provide a system, apparatus, and method to manage press releases that overcome many or all of the above-discussed shortcomings in the art.

In one aspect of the present invention, a press release system includes a press release server that serves up a first web page with a press release management console and receives a press release and trackback management settings therethrough. Subsequently, the press release server may serve up a second web page with the press release and a press release trackback Uniform Resource Locator (“URL”). The press release server receives trackback requests at an address corresponding to the press release trackback URL and manages the trackback requests according to the trackback management settings.

In certain embodiments, the press release server notifies a user upon reception of each trackback request. In some embodiments, the press release server includes a trackback post corresponding to a trackbcak request, in the second web page. In such embodiments, the server may include the trackback post in response to user approval of the trackback request. In certain embodiments, the press release server regulates the number of trackback requests receivable over a selected period of time. In some embodiments, the press release server sends a trackback request to a second address corresponding to a trackback URL of a related web page received through the press release management console.

In another aspect of the present invention, a press release server includes a user communication module that serves up a first web page with a press release management console and receives a press release and trackback management settings therethrough. The server may also include a press release publication module that serves up a second web page with the press release and a press release trackback URL. The server may also includes a trackback management module that receives trackback requests at a first address corresponding to the press release trackback URL and manages the trackback requests according to the trackback management settings.

In certain embodiments, the trackback management module incorporates a trackback post corresponding to the trackback request in the second web page. A trackback post may include a link to a related web page, text of a related web page, and a window for viewing a related web page. Trackback management settings may include a setting enabling trackback referencing, a setting requiring a user to be notified of trackback requests, and a setting requiring user approval of trackback posts. In certain embodiments, the trackback management module sends a trackback request to a second address corresponding to the trackback URL of a related web page received through the press release management console.

In another aspect of the present invention a method to link a press release with a related web page includes the operations of serving up a first web page with a press release management console, receiving a press release and trackback management setting through the press release management console, serving up a second web page with the press release and a press release trackback URL, receiving a first trackback request at a first address corresponding to the press release trackback URL, and managing the first trackback request according to the trackback management settings. In certain embodiments, the method also includes sending a trackback request to a second address corresponding to a trackback URL of a related web page received through the press release management console.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one embodiment of an press release system in accordance with the present invention;

FIG. 2 is a block diagram illustrating one embodiment of an press release server in accordance with the present invention;

FIG. 3a is a flow chart diagram illustrating one embodiment of a method for serving up a press release in accordance with the present invention;

FIG. 3b is a flow chart diagram illustrating one embodiment of a method for linking a press release with a related web page in accordance with the present invention;

FIG. 4 is a flow chart diagram illustrating one embodiment of a method for managing a trackback request in accordance with the present invention;

FIG. 5 is a screenshot illustrating one embodiment of a press release in accordance with the present invention;

FIG. 6 is a screenshot illustrating one embodiment of a press release management console in accordance with the present invention; and

FIG. 7 is a screenshot illustrating one embodiment of a press release management console in accordance with the present invention.

### DETAILED DESCRIPTION OF THE INVENTION

It will be readily understood that the components of the present invention, as generally described and illustrated in the Figures herein, may be arranged and designed in a wide variety of different configurations. Thus, the following more detailed description of the embodiments of the apparatus, method, and system of the present invention is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The features, structures, or characteristics of the invention described throughout this specification may be combined in any suitable manner in one or more embodiments. For example, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” or similar language throughout this specification do not necessarily all refer to the same embodiment and the described features, structures, or characteristics may be combined in any suitable manner in one or more embodiments.

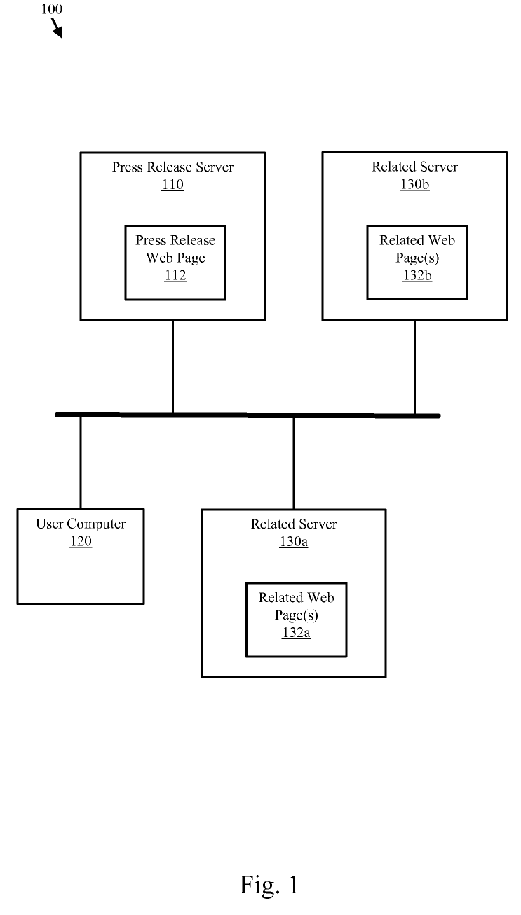

FIG. 1 is a block diagram of one embodiment of a press release reference system 100 in accordance with the present invention. The depicted system 100 includes a press release server 110, a user computer 120, and one or more related servers 130. As depicted, the press release server 100 includes a press release web page 112 (also referred to herein as “a second web page”) and the related servers 130 include one or more related web pages 132. In some embodiments, the press release server 110 and the related servers 130 are the same server. The components of the system 100 enhance press release publication by including trackback posts of the related web pages 132 in the press release web page 112 and including a trackback post of the press release web page 112 in the related web pages 132.

In certain embodiments, the press release server 110 serves up a first web page with a press release management console to the user computer 120, through which a user enters a press release, trackback management settings, and Trackback Uniform Resource Locators (“URLs”) for related web pages. In certain embodiments, the press release server 110 serves up a second web page 112 with a press release and a press release trackback URL. The press release trackback URL maps to an address to which trackback requests maybe sent.

In certain embodiments, the press release sever 110 receives trackback requests from the related servers 130. Each trackback request may include information corresponding to a related web page 132. In certain embodiments, the press release server 110 manages each trackback request according to the trackback management settings. As such, the press release server 110 may perform a variety of operations such as including a trackback post of a related web page 132 in the press release web page 112. Referencing a related web page 132 in this manner increases the pool of information readily available to a press release viewer.

In certain embodiments, the press release server 110 sends trackback requests to the related servers 130 according to the trackback URL of a related web page. Each trackback request may include information corresponding to the press release web page 112. The related servers 130 may include a trackback post of the press release web page 112 in the related web pages 132. As such, the press release server 110 is capable of increasing press release exposure by sending trackback requests, resulting in a trackback post of the press release web page 112 in one or more related web pages 130.

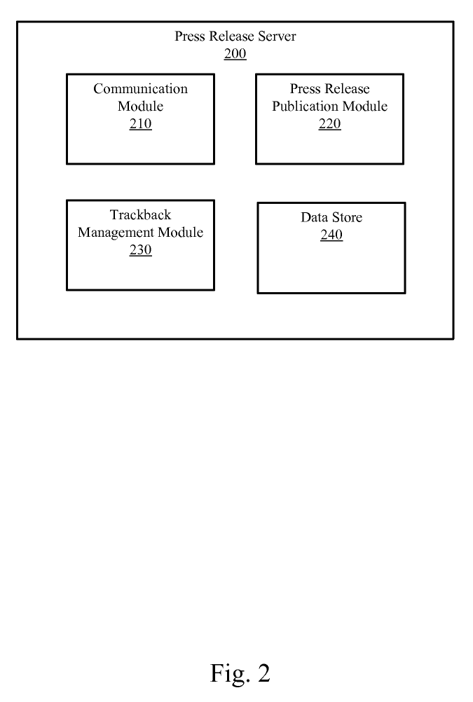

FIG. 2 is a block diagram illustrating one embodiment of a press release server 200 in accordance with the present invention. The depicted press release server 200 includes a user communication module 210, a press release publication module 220, a trackback management module 230, and a data store 240. The modules of the server 200 cooperate to manage a press release and link press releases with one or more related web pages.

In certain embodiments, the user communication module 210 serves up a first web page with a press release management console (not shown) and receives a press release, trackback management settings, and trackback URLs for related web pages through the management console. Trackback management settings may include instructions for managing trackback requests and the trackback URLs for related web pages may map to an address to which trackback requests may be sent. The press release, trackback management settings, and trackback URLs of related web pages may be stored in the data store 250. In certain embodiments, the press release publication module 220 serves up the press release in a second page with a press release trackback URL.

In certain embodiments, the trackback management module 230 receives trackback requests and manages the trackback requests according to the trackback management settings. As such, the trackback management module 230 may include a trackback post of a related web page in the press release web page. In some embodiments, a trackback post may include a link to, and text from, the related web page. In certain embodiments, a trackback post may include a window for viewing the related web page within the press release web page. Accordingly, the trackback management module 230 may create a pool of information that discusses, verifies, or otherwise relates to the press release.

In addition to including a trackback post, the trackback management module 230 may notify the user of the trackback request via email or otherwise. In such embodiments, the trackback management module 230 may include a trackback post of a related web page upon receiving approval from the user. In other embodiments, the trackback management module will include a trackback post to a related web page and notify the user of the trackback request. In some embodiments, the trackback management module 230 enables a user to remove an unwanted trackback post from the press release web page. Accordingly, the operations undergone by the trackback management module 230 may be customized according to user preference.

In certain embodiments, the trackback management module 230 regulates the number of trackback requests receivable over a selected period of time. For example, if the reception of a trackback request exceeds the number of requests acceptable over a selected period of time, the trackback request may be ignored by the trackback management module 230. Regulating the number of notifications receivable decreases the probability that an unwanted or “spammed” trackback post will be included in the press release web page.

In certain embodiments, the trackback management module 240 communicates trackback requests in accordance with the trackback URLs of related web pages. In certain embodiments, a trackback post of the press release web page will be included in the related web pages in response to receiving the trackback request. Accordingly, the trackback management module 240 enhances press release exposure by proactively sending trackback requests to related web pages.

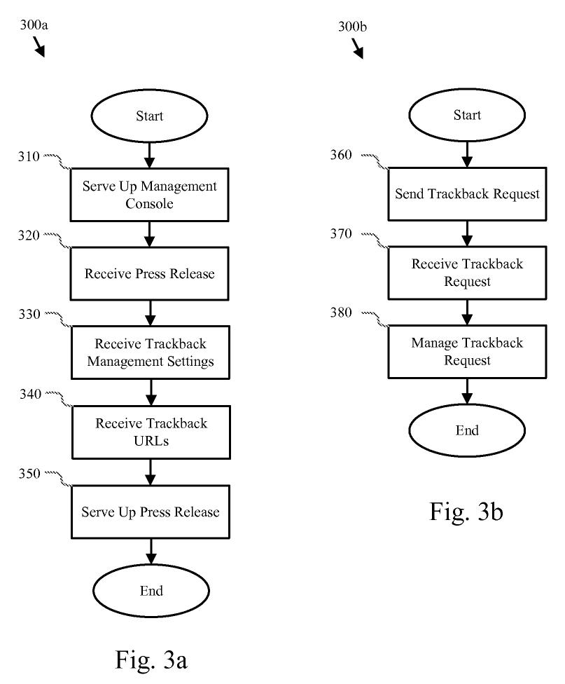

FIG. 3a is a flow chart diagram illustrating one embodiment of a method 300a for serving up a press release in accordance with the present invention. The depicted method 300a includes the operations of serving up 310 a management console, receiving 320 a press release, receiving 330 trackback management settings, receiving 340 trackback URLs for related web pages, and serving up 350 the press release. The depicted method 300a illustrates a process typical of the present invention for publicizing a press release.

Serving up 310 a management console may include executing a local script to provide a user with a press release management console in a first web page. Receiving 320 a press release may include the user entering a press release title, summary, and press release body through the press release management console. Receiving 330 trackback management settings may include the user selecting or unselecting certain settings options provided in the press release management console.

Receiving 340 trackback URLs may include the user entering one or more trackback URLs for related web pages into a text box of the press release management console. Serving up 350 the press release may include a press release server serving up a second web page with the press release and a press release Trackback URL. Accordingly, the method 300a provides a simple, user-friendly solution to publicizing a press release via the press release management console.

FIG. 3b is a flow chart diagram illustrating one embodiment of a method 300b for linking a press release with a related web page in accordance with the present invention. The depicted method 300b includes sending 360 trackback requests, receiving 370 trackback requests, and managing 380 trackback requests. The operations of the method 300b send and receive trackback requests between the press release web page 112 and the related web pages 132.

Sending 360 trackback requests may include sending a trackback request to one or more trackback URLs for related web pages received through the press release management console. Receiving 370 trackback requests may include a press release server 110 receiving a trackback request from a related server 130 with one or more related web page 132. Managing 380 trackback requests may include managing each trackback request according to the trackback management settings received through the press release management console. Managing 370 the trackback requests may include various operations such as including a trackback post of a related web page 132 in the press release web page 112 or notifying a user of the trackback request.

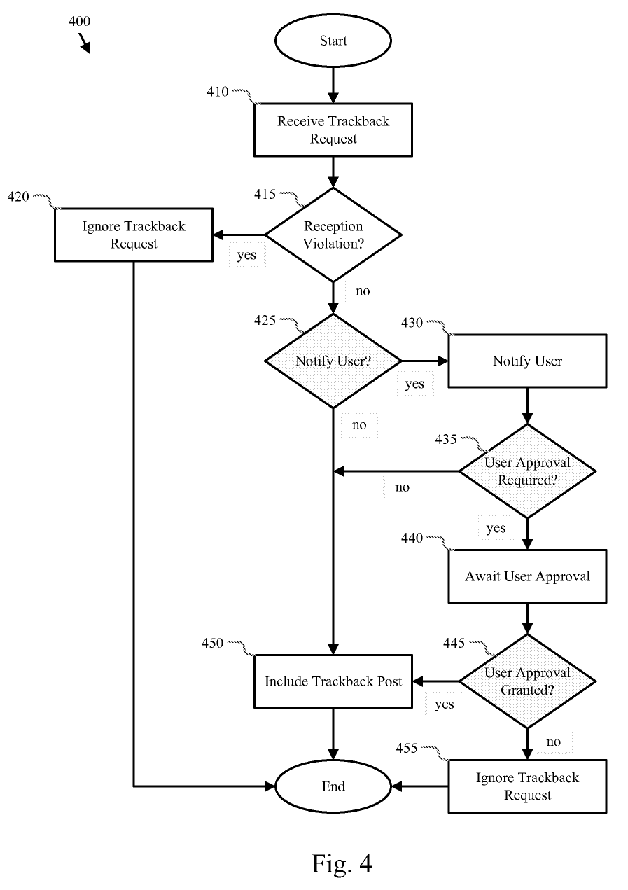

FIG. 4 is a flow chart diagram illustrating one embodiment of a trackback request management method 400 in accordance with the present invention. The depicted method 400 includes the operations of receiving 410 a trackback request, determining 415 whether a reception violation has occurred, ignoring 420 the trackback request, determining 425 if the user must be notified of the trackback request, notifying 430 the user, determining 435 if user approval is required to include a trackback post, awaiting 440 user approval, determining 445 if user approval is granted, including 450 a trackback post of the related web page, and ignoring 455 the trackback request. The operations of the method 400 illustrate one of many possible embodiments for managing trackback request.

Receiving 410 a trackback request may include a press release server 110 receiving a trackback request from a related server 130. Determining 415 whether a reception violation has occurred may include a variety of assessments such as determining if too many trackback requests have been received over a selected period of time. If reception of the trackback request is a reception violation, the request may be ignored 420. Ignoring trackback requests that create a reception violation decreases the probability that a “spammed” trackback requests will be incorporated in a web page.

If no reception violation has occurred, a script may be invoked to determine 425 whether a user should be notified of the trackback request. Whether the user should be notified may depend upon the trackback management settings received 330 from the user through the press release management console (see FIG. 3a). If the user need not be notified, a trackback post of a related web page 132 may be included 450 in the press release web page 112. However, if the user must be notified, then an email or other notification may be sent to the user.

After notifying 430 the user, a local script may ascertain, as per the trackback management settings, whether 435 user approval of the trackback request must be granted before including a trackback post of the related web page 132 in the press release web page 112. If user approval is not required, then a trackback post of the related web page 132 may be included. If user approval is required, then an await 440 user approval operation may be performed.

In certain embodiments, if user approval is granted 445 then a trackback post of the related web page is included 450 in the press release web page. However, if user approval is not granted, then the trackback request may be ignored 455. Accordingly, the method 400 illustrates one embodiment for managing trackback requests that enables spam filtering and user approval in the press release referencing process.

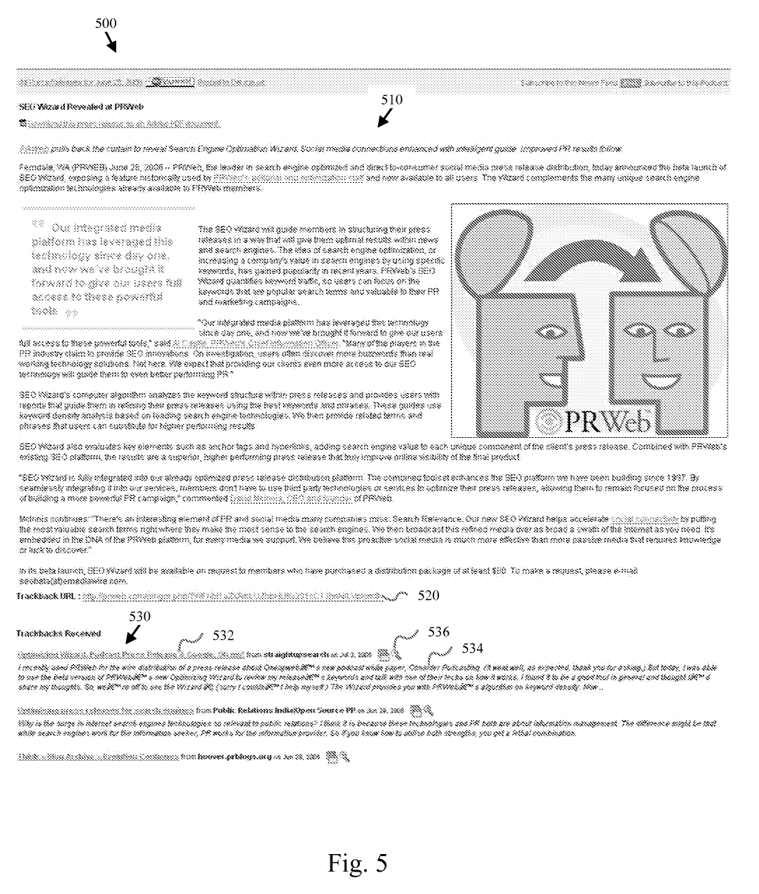

FIG. 5 is a screenshot illustrating one embodiment of a press release web page 500 in accordance with the present invention. The depicted press release 500 includes a press release 510 that is substantially text and pictures. In some embodiments, the press release 510 may include an audio or video file. The press release trackback URL 520 provides a destination for related web pages 132 to send a trackback request to the press release web page 500.

The depicted trackback post 530 includes a link to 532, and text of 534, a related web page (not shown). If a press release viewer where to select the icon 536, a window within the press release web page 500 would expand and display the actual related web page. In certain embodiments, the press release web page 500 will elongate to accommodate additional trackback posts. Accordingly, a press release web page 500 of the present invention may provide a trackback URL to facilitate receiving trackback requests and a location for including trackback posts.

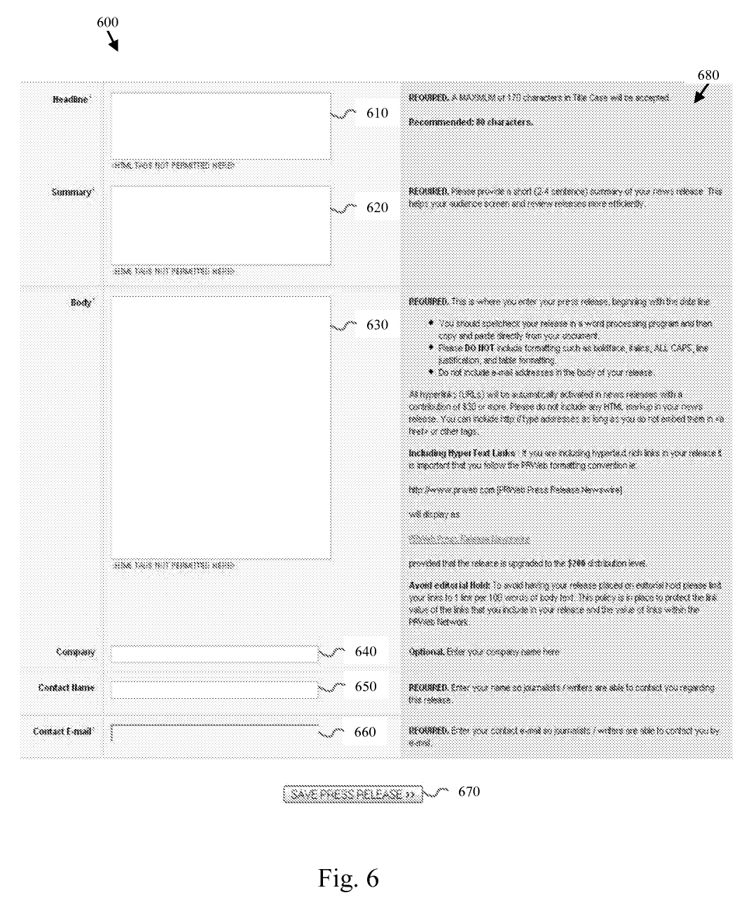

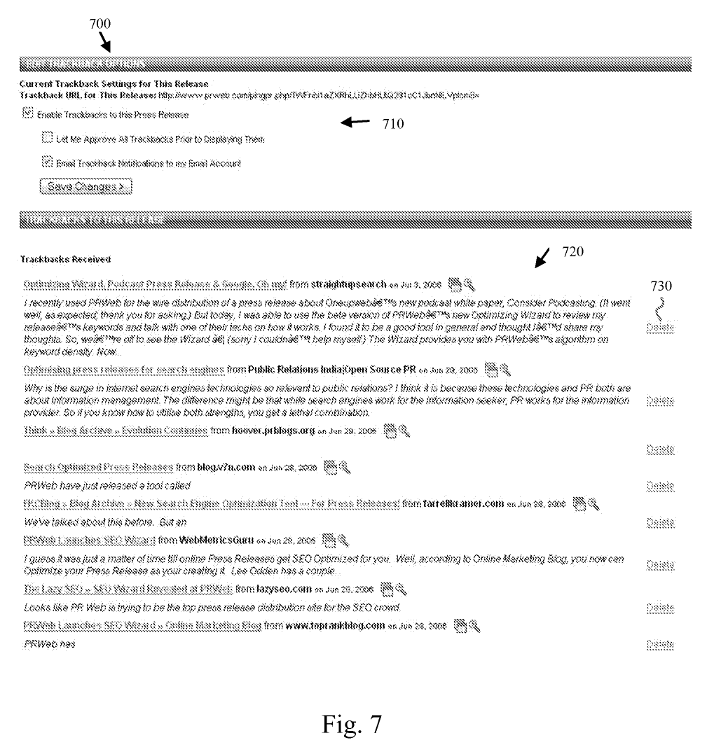

FIG. 6 is press release management console 600 through which a user may submit a press release. As illustrated in FIGS. 6 and 7, the functionality of the press release management console may be partitioned into one or more web pages comprising a variety of interface controls. The depicted press release management console 600 includes text boxes for submitting a press release headline or title 610, a press release summary 620, and a press release body 630. The depicted press release management console 600 also includes text boxes for submitting a company name 640 a contact name 650, and a contact email 660. The contact information may be used to notify the user of the reception of trackback requests. The press release management console also includes instructions 680 to facilitate press release submission and a button 670 for saving the press release information.

FIG. 7 is a screenshot illustrating one embodiment of a press release management console 700 in accordance with the present invention. The depicted press release management console 700 includes a trackback request management settings section 710 where a user may select and save management settings related to trackback requests. The management console 700 also includes a list of all the trackback posts 720 included in the press release web page. Listing the trackback posts enables the user to view each trackback post and remove a trackback post by selected a delete link 730 corresponding to the trackback post. Accordingly, the press release management console enables a user to customize trackback management settings and manage current trackback posts.

In some embodiments, the management console 700 may also include one or more controls for submitting trackback URLs for related web pages and a link to send trackback requests according to addresses corresponding to the related web page trackback URLs. In such an embodiment, after a trackback request for a trackback URL of a related web page has been sent, the trackback URL may be included in a list intended to provide a record for which of trackback requests sent.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system to manage press releases, the system comprising:
a press release server configured to serve up a first web page comprising a press release management console;
the press release server further configured to receive a press release through the press release management console;
the press release server further configured to receive trackback management settings through the press release management console;
the press release server further configured to serve up a second web page comprising the press release and a press release trackback URL;
the press release server further configured to receive trackback requests at a first address corresponding to the press release trackback URL; and
the press release server further configured to manage the trackback requests according to the trackback management settings.

2. The system of claim 1, wherein the press release server is further configured to notify a user upon reception of a trackback request.

3. The system of claim 1, wherein the press release server is further configured to include a trackback post corresponding to the trackback request within the second web page.

4. The system of claim 3, wherein the trackback post is included in response to user approval of the trackback request.

5. The system of claim 4, wherein the trackback post is selected from the group consisting of a link to a related web page, text of a related web page, and a window for viewing a related web page.

6. The system of claim 1, wherein the trackback management settings are selected from the group consisting of a setting enabling trackback posts, a setting requiring a user to be notified of trackback requests, and a setting requiring user approval of trackback posts.

7. The system of claim 1, wherein the press release server is further configured to regulate the number of trackback requests receivable over a selected period of time.

8. The system of claim 1, wherein the press release server is further configured to remove an unwanted trackback post from the second web page.

9. The system of claim 1, wherein the press release server is further configured to send a trackback request to a second address corresponding to a trackback URL of a related web page received through the press release management console.

10. An apparatus to manage press releases, the apparatus comprising:
a user communication module configured to serve up a first web page comprising a press release management console;
the user communication module further configured to receive a press release and trackback management settings through the press release management console;
a press release publication module configured to serve up a second web page comprising the press release and a press release trackback URL; and
a trackback management module configured to receive trackback requests at a first address corresponding to the press release trackback URL and manage the trackback requests according to the trackback management settings.

11. The apparatus of claim 10, wherein the trackback management module is further configured to notify a user upon reception of a trackback request.

12. The apparatus of claim 10, wherein the trackback management module is further configured to include a trackback post corresponding to the trackback request in the second web page.

13. The apparatus of claim 12, wherein the trackback post is included in response to user approval of the trackback request.

14. The apparatus of claim 13, wherein the trackback post is selected from the group consisting of a link to a related web page, text of a related web page, and a window for viewing a related web page.

15. The apparatus of claim 10, wherein the trackback management settings are selected from the group consisting of a setting enabling trackback referencing, a setting requiring a user to be notified of trackback requests, and a setting requiring user approval of trackback posts.

16. The apparatus of claim 10, wherein the trackback management module is further configured to regulate the number of trackback requests receivable over a selected period of time.

17. The apparatus of claim 10, wherein the trackback management module is further configured to remove an unwanted trackback post from the second web page.

18. The apparatus of claim 10, wherein the trackback management module is further configured to send a trackback request to a second address corresponding to a trackback URL of a related web page received through the press release management console.

19. A method to manage press releases, the method comprising:
serving up a first web page comprising a press release management console;
receiving a press release through the press release management console;
receiving trackback management settings through the press release management console;
serving up a second web page comprising the press release and a press release trackback URL;
receiving a first trackback request at a first address corresponding to the press release trackback URL; and
managing the first trackback request according to the trackback management settings.

20. The method of claim 19, wherein managing the first trackback request according to the trackback management settings comprises notifying a user upon reception of the first trackback request.

21. The method of claim 19, wherein managing the first trackback request according to the trackback management settings comprises including a trackback post corresponding to the trackback request in the second web page.

22. The method of claim 21, wherein the trackback post is included in response to user approval of the trackback request.

23. The method of claim 22, wherein the trackback post is selected from the group consisting of a link to a related web page, text of a related web page, and a window for viewing a related web page.

24. The method of claim 19, wherein the trackback management settings are selected from the group consisting of a setting enabling trackback post, a setting requiring a user to be notified of trackback requests, and a setting requiring user approval of trackback posts.

25. The method of claim 19, further comprising regulating the number of trackback requests receivable over a selected period of time.

26. The method of claim 19, further comprising removing an unwanted trackback post from the second web page.

27. The method of claim 19, further comprising sending a second trackback request to a second address corresponding to a trackback URL of a related web page received through the press release management console.

28. An apparatus to manage press releases, the apparatus comprising:
at least one interface control configured to enable a user to submit a press release;
at least one interface control configured to enable a user to specify at least one trackback management setting; and
at least one interface control configured to enable a user to remove a trackback post.

29. The apparatus of claim 28, further comprising at least one interface control configured to enable a user to enter a trackback URL for a related web page.

30. The apparatus of claim 28, further comprising at least one interface control configured to enable a user to submit user contact information.
